(19) United States
(12) Patent Application Publication
(10) Pub. No.: US 2020/0144872 A1
(43) Pub. Date: May 7, 2020

(54) ELECTRIFIED VEHICLE

(71) Applicant: Toyota Jidosha Kabushiki Kaisha, Toyota-shi Aichi-ken (JP)

(72) Inventor: Kensuke Kamichi, Nagakute-shi (JP)

(73) Assignee: Toyota Jidosha Kabushiki Kaisha, Toyota-shi Aichi-ken (JP)

(21) Appl. No.: 16/545,600

(22) Filed: Aug. 20, 2019

(30) Foreign Application Priority Data
Nov. 7, 2018 (JP) 2018-209484

(51) Int. Cl. H02J 50/90; B60L 50/51; B60L 50/60; B60L 53/12; B60L 53/30; G06F 3/14

(52) U.S. Cl. CPC H02J 50/90; B60L 50/51; B60L 50/60; B60L 53/12; B60R 1/00; G06F 3/14; B60L 2210/40; B60Y 2200/91; B60Y 2300/91; B60L 53/30

(57) ABSTRACT

In an electrified vehicle, when a position of an electric power transmitting coil is out of a predetermined distance range from the vehicle, display is performed by a first display method using a first vehicle schematic diagram and a first coil schematic diagram of the electric power transmitting coil based on a position relationship detected by a first coil position detection sensor. When the position of the electric power transmitting coil is within the predetermined distance range from the vehicle, display is performed by a second display method using a second vehicle schematic diagram that specifies a center position of an electric power receiving roil in the first vehicle schematic diagram and a second coil schematic diagram that specifies a center position of the electric power transmitting coil in the first coil schematic diagram based on a position relationship detected by a second coil position detection sensor with good accuracy.

### CROSS-REFERENCE TO RELATED APPLICATIONS

This application claim priority to Japanese Patent Application No. 2018-209484 filed on Nov. 7, 2018, the disclosure of which is incorporated herein by reference in its entirety.

### BACKGROUND

### 1. Technical Field

The disclosure relates to an electrified vehicle, and more particularly, to an electrified vehicle including an electric power receiving coil that receives power for charging an electric power storage device.

### 2. Description of Related Art

In the related art, an electrified vehicle is disclosed in which, when a distance between the vehicle and a target parking position becomes smaller than a predetermined value, on a display, a first image captured by a rear camera during parking the vehicle is switched to a second image including information on position alignment that cannot be obtained by the first image (see, for example, Japanese Unexamined Patent Publication No. 2011-015549 (JP 2011-015549 A)).

In addition, an electrified vehicle is also disclosed in which, when the vehicle comes close to the charging stand, on a display, an image captured by a rear camera during parking the vehicle at the charging stand is switched to an image captured by a underfloor camera attached to the floor of the vehicle (see, for example, Japanese Unexamined Patent Application Publication No. 2011-182608 (JP 2011-182608 A)). When the image captured by the underfloor camera is displayed in the electrified vehicle, the center positions of an electric power receiving coil and an electric power transmitting coil are also displayed.

### SUMMARY

Although, while the electrified vehicle is parking at a non-contact charging stand, the display switches between two different images according to the distance between the vehicle and an electric power transmitting coil of the charging stand, the two images may not have any continuity. In this case, when one image is switched to the other, a driver may feel a sense of discomfort in regard to the positions of the vehicle and the electric power transmitting coil.

The disclosure provides an electrified vehicle capable of suppressing the sense of discomfort caused by image switching during parking of the vehicle at a non-contact charging stand.

The electrified vehicle according to the disclosure has the following aspect.

An aspect of the disclosure relates an electrified vehicle. The electrified vehicle includes a motor, an electric power storage device, an electric power receiving coil, a display, a control device, a first coil position detection sensor, and a second coil position detection sensor. The motor is configured to output power for traveling, an electric power storage device is configured to supply electric power to the motor, the electric power receiving coil is configured to receive electric power that charges the electric power storage device, and a display is disposed in a vicinity of a driver's seat. The first coil position detection sensor is configured to detect a relationship between a position of an electric power transmitting coil located outside the vehicle and a position of the electric power receiving coil with first accuracy when the vehicle is out of a predetermined distance range. The second coil position detection sensor is configured to detect the relationship between the position of the electric power transmitting coil and the position of the electric power receiving coil with second accuracy that is more accurate than the first accuracy when the vehicle is within the predetermined distance range. The control, device is configured to, when the position of the electric power transmitting coil is out of the predetermined distance range from the vehicle, perform display on the display by a first display, method of displaying the position of the vehicle and the position of the electric power transmitting coil using a first vehicle schematic diagram that schematically shows a plane of the vehicle and a first coil schematic diagram that schematically shows the electric power transmitting coil based on the relationship between the position of the electric power transmitting coil and the position of the electric power receiving coil detected by the first coil position detection sensor, and when the position of the electric power transmitting coil is within the predetermined distance range from the vehicle, perform display on the display by a second display method of displaying the position of the vehicle and the position of the electric power transmitting coil using a second vehicle schematic diagram that specifies a center position of the electric power receiving coil in the first vehicle schematic diagram and a second coil schematic diagram that specifies a center position of the electric power transmitting coil in the first coil schematic diagram based on the relationship between the position of the electric power transmitting coil and the position of the electric power receiving coil detected by the second coil position detection sensor.

The electrified vehicle according to the aspect includes the first coil position detection sensor configured to detect a relationship between the position of an electric power transmitting coil outside the vehicle and the position of the electric power receiving coil with first accuracy when the vehicle is out of the predetermined distance range, and the second coil position detection sensor configured to detect the relationship between the position of the electric power transmitting, coil and the position of the electric power receiving coil with second accuracy that is more accurate than the first accuracy when the vehicle is within the predetermined distance range. Then, the control device is configured to, when the position of the electric power transmitting coil is out of the predetermined distance range from the vehicle, perform display on the display by the first display method of displaying the position of the vehicle and the position of the electric power transmitting coil using a first vehicle schematic diagram and a first coil schematic diagram, where the first vehicle schematic diagram schematically shows the plane of the vehicle and the first coil schematic diagram schematically shows the electric power transmitting coil based on the relationship between the position of the electric power transmitting coil and the, position of the electric power receiving coil detected by the first coil position detection sensor. On the other hand, the control device is configured to, when the position of the electric power transmitting coil is within the predetermined distance range from the vehicle, perform display on the display by the second display method of displaying the position of the vehicle and the position of the electric power transmitting coil using a second vehicle schematic diagram and a second coil schematic diagram, where the second vehicle schematic diagram specifies the center position of the electric power receiving coil in the first vehicle schematic diagram and the second coil schematic diagram specifies the center position of the electric power transmitting coil in the first coil schematic diagram based on the relationship between the position of the electric power transmitting coil detected by the second coil position detection sensor and the position of the electric power receiving coil. Since the second vehicle schematic diagram specifies the center position of the electric power receiving coil in the first vehicle schematic diagram, continuity is achieved even when the first vehicle schematic diagram is switched to the second vehicle schematic diagram. In addition, since the second coil schematic diagram specifics the center position of the electric power transmitting coil in the first coil schematic diagram, continuity is achieved even when the first coil schematic diagram is switched to the second coil schematic diagram. As a result, when the first display method is switched to the second display method, continuity of images is achieved, which makes it possible to suppress inconvenience (the inconvenience of giving a sense of discomfort to a driver) occurring caused by lack of image continuity.

In the electrified vehicle according to the aspect of the disclosure, the control device may perform switching from the first display method to the second display method and switching from the second display method to the first display method with hysteresis. For example, when the vehicle goes into the distance range and the distance between the vehicle and the position of the electric power transmitting coil gets smaller than the predetermined distance by a margin, the first display method may be switched to the second display method, and when the vehicle moves from the predetermined distance range and the distance between the vehicle and the position of the electric power transmitting gets larger than the predetermined distance range, the second display method may be switched to the first display method. In this way, frequent switching between the first display method and the second display method can be suppressed.

In the electrified vehicle according to the aspect of the disclosure, the first display method may be a method of displaying a guide line, with a smooth curve, toward the center of the first coil schematic diagram from the center of an end located closed to the electric power transmitting coil among both vehicle front and rear ends of the first vehicle schematic diagram. In this way, the operation of the vehicle for parking at the position of the electric power transmitting coil can be easily performed. In addition, the second display method may be a method of displaying a guide line, with a smooth curve, toward the center position of the electric power transmitting coil from the center position of the electric power receiving coil. In this way, the operation of the vehicle for parking such that the center position of the electric power receiving coil coincides with the center position of the electric power transmitting coil.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram schematically illustrating a non-contact electric power transmitting and reception system 10 including an electric vehicle 20 and an electric power transmitting device 130 according to an embodiment of the disclosure;

FIG. 2 is a configuration diagram schematically illustrating the non-contact electric power transmitting and reception system 10 including the electric vehicle 20 and the electric power transmitting device 130;

FIG. 3 is a flowchart illustrating one example of a position display process executed by a vehicle ECU 70;

FIG. 4 is an exemplary diagram illustrating an example of a guidance map 200 by a first display method;

FIG. 5 an exemplary diagram illustrating an example of a guidance map 300 by a second display method; and

FIG. 6 is a flowchart illustrating one example of a position display process according to a modified example.

### DETAILED DESCRIPTION

Hereinafter, an embodiment of the disclosure will be described.

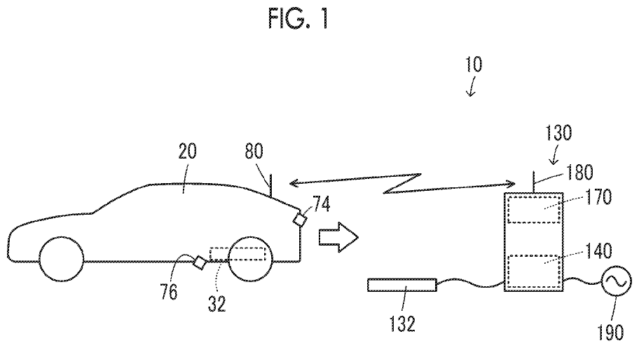

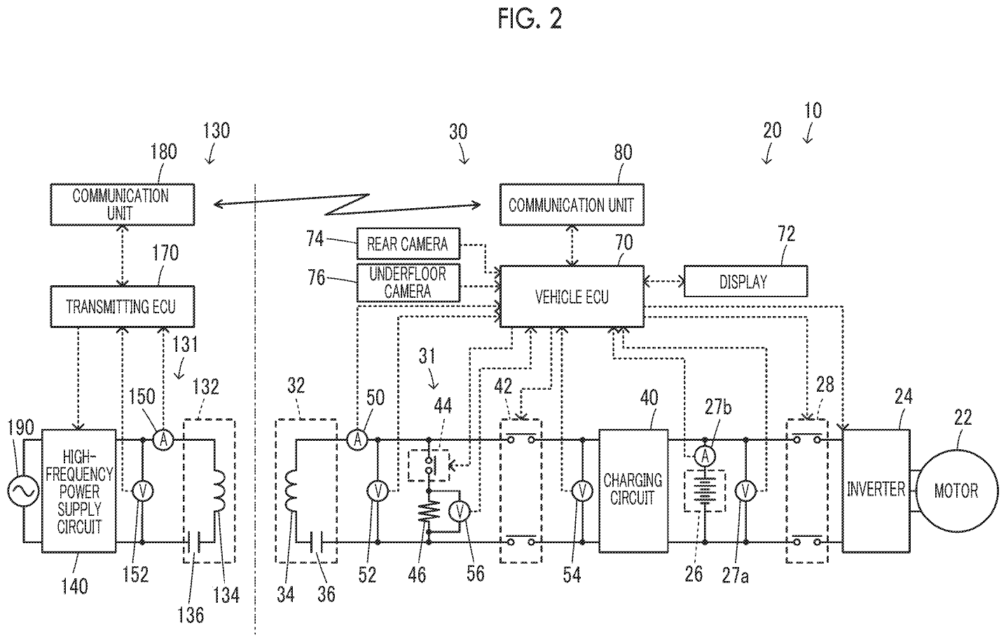

FIGS. 1 and 2 are configuration diagrams schematically illustrating a non-contact electric power transmitting and reception system 10 including an electric vehicle 20 and an electric power transmitting device 130 according to an embodiment of the disclosure. The electric vehicle 20 of the embodiment constitutes the non-contact power transmitting and reception system 10 together with the electric power transmitting device 130 outside the electric vehicle.

The electric power transmitting device 130 includes an electric power transmitting unit 131 connected to an alternating current power supply (AC power supply) 190, an electronic control unit for electric power transmitting 170 (hereinafter, referred to as “electric power ECU”), which is configured to control the electric power transmitting unit 131, and a communication unit 180 that communicates with the electric power transmitting ECU 170 and that wirelessly communicates with a communication unit 80 (which will be described later) of the electric vehicle 20, as well.

The electric power transmitting unit 131 includes an electric power transmitting resonant circuit 132 and a high-frequency power supply circuit 140 provided between the AC power supply 190 and the electric power transmitting resonant circuit 132. Here, the electric power transmitting resonant circuit 132 has an electric power transmitting coil 134 installed on the floor of a parking lot or the like, and a capacitor 136 connected in series to the electric power transmitting coil 134. The high-frequency power supply circuit 140 serves to convert electric power from the AC power supply 190 into electric power of a predetermined frequency Fset and output the converted electric power to the electric power transmitting resonant circuit 132, and has a filter, a frequency conversion circuit, a leakage breaker, and the like.

The electric power transmitting ECU 170 may be a central processing unit (CPU)-based microprocessor (not illustrated), and includes, in addition to the CPU, a read only memory (ROM) storing processing programs, a random access memory (RAM) storing data temporarily, input/output ports, and a communication port. A current Itr of the electric power transmitting resonant circuit 132 from a current sensor 150 that detects the AC current passing through the electric power transmitting resonant circuit 132, an inter-terminal voltage (power transmitting voltage) Vtr of the electric power transmitting resonant circuit 132 from a voltage detection unit 152 that converts the AC voltage across the terminals of the electric power transmitting resonant circuit 132 into a direct-current (DC) voltage and detects the converted DC voltage, or the like, are input to the electric power transmitting ECU 170 through the input port. Furthermore, the voltage detection unit 152 has a rectifier circuit and a voltage sensor. Control signals to be transmitted to the high-frequency power supply circuit 140, and the like, is output from the electric power transmitting ECU 170 through the output port.

The electric vehicle 20 includes a motor 22 for traveling, an inverter 24 for driving the motor 22, a battery 26 exchanging electric power with the motor 22 through the inverter 24, a system main relay 28 installed between the inverter 24 and the battery 26, art electric power receiving unit 31 connected to the battery 26, a vehicle electronic control unit 70 (hereinafter, referred to as “vehicle ECU”) controlling the entire vehicle, and a communication unit 80 communicating with the vehicle ECU 70 and wirelessly communicating with the communication unit 180 of the electric power transmitting device 130.

The electric power receiving unit 31 includes an electric power receiving resonant circuit 32, a charging circuit 40 installed between the electric power receiving resonant circuit 32 and the battery 26, a charging relay 42 installed between the electric power receiving resonant circuit 32 and the charging circuit 40, and a relay 44 and resistor 46 provided between the electric power receiving resonant circuit 32 and the charging relay 42 and connected in parallel to the electric power receiving resonant circuit and in series to each other. The electric power receiving resonant circuit 32 includes an electric power receiving coil 34 installed on the vehicle body bottom (floor panel) or the like, and a capacitor 36 connected in series to the electric power receiving coil 34. The electric power receiving resonant circuit 32 is designed such that the resonant frequency is a frequency (ideally, the predetermined frequency Fset) near the predetermined frequency Fset (the resonant frequency of the electric power transmitting resonant circuit 132) described above. The charging circuit 40 may be a circuit capable of converting the AC electric power received by the electric power receiving resonant circuit 32 into DC electric power and the converted DC electric power to the battery 26, and includes a rectifier circuit, smoothing circuit, or the like. The charging relay 42 performs connection and disconnection between the electric power receiving resonant circuit 32 and the charging circuit 40. The relay 44 performs connection and disconnection between a line and one terminal of the resistor, where the line is positioned on the positive side between the electric power receiving resonant circuit 32 and the charging relay 42, and the other terminal is connected to another line on the negative side between the electric power receiving resonant circuit 32 and the charging relay 42.

The vehicle ECU 70 (not illustrated) may be a CPU-based microprocessor, and includes, in addition to the CPU, a ROM storing processing programs, a RAM storing data temporarily, input/output ports, and a communication port. A rotational position θm of a rotor of the motor 22 from a rotational position detection sensor that detects the rotational position of the rotor of the motor 22, phase currents Iu, Iv, Iw from a current sensor that detects current flowing in each phase of the three-phase coil of the motor 22, a battery voltage Vb from a voltage sensor 27a installed between terminals of the battery 26, a battery current Ib from a current sensor 27b attached to the terminal on the positive side of the battery 26, and a battery temperature Tb from a temperature sensor that detects temperature of the battery 26, and the like, are input to the vehicle ECU 70 through the input port. In addition, an ignition signal from an ignition switch (start switch), a shift position SP from a shift position sensor that detects the operation position of a shift lever, an accelerator operation amount Acc from accelerator pedal position sensor that detects an amount of depression of an accelerator pedal, a brake pedal position BP from a brake pedal position sensor that detects an amount of depression of the brake pedal, a vehicle speed V from a vehicle speed sensor, or the like, are input to the vehicle ECU 70 through the input port. Furthermore, a current Ire of the electric power receiving resonant circuit 32 from a current sensor 50 that detects an AC current flowing in the electric power receiving resonant circuit 32, an inter-terminal voltage (electric power receiving voltage) Vre1 of the electric power receiving resonant circuit 32 from a voltage detection unit 52, an inter-terminal voltage Vre2 on the input side of the charging circuit 40 from a voltage detection unit 54, an, inter-voltage Vre3 of the resistor 46 from a voltage detection unit 56, a temperature Tre of the electric power receiving resonant circuit 32 from a temperature sensor attached to a substrate and the like on which the electric power receiving resonant circuit 32 are mounted, or the like, are input to the vehicle ECU 70 through the input port. In addition, an image rearward of the vehicle from a rear camera 74 attached to the rear portion of the vehicle, and an image below and the rear portion of the vehicle from a underfloor camera 76 attached substantially to the center portion of the lower floor of the vehicle (forward of the electric power receiving coil 34) are also input to the vehicle ECU 70.

Switching control signals of switching elements (not illustrated) of the inverter 24, on/off signals to the system main relay 28, on; off signals to the charging relay 42, on/off signals to the relay 44, display control signals to the display 72 (for example, a display of a navigation device) that displays information, or the like are output to the vehicle ECU 70 through the output port. The vehicle ECU 70 calculates a charging ratio SOC of the battery 26 based on the integrated value of the battery current Ib of the battery 26 detected by the current sensor 27b.

In the electric vehicle 20 of the embodiment configured as described above, in a state where the vehicle is parked such that the electric power receiving coil 34 mounted on the vehicle are aligned with the electric power transmitting coil 134 of the electric power transmitting device 130, the battery 26 is charged by the electric power receiving coil 34 receiving electric power from the electric power transmitting device 130.

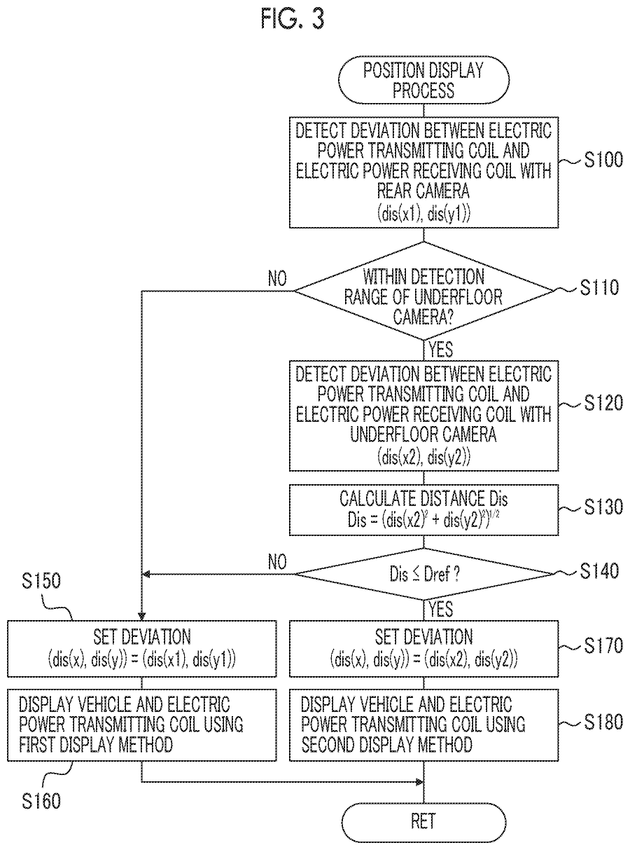

Next, while the electric vehicle 20 is parking such that the electric power receiving coil 34 is aligned with the electric power transmitting coil 134, operations in displaying positions the vehicle and the electric power transmitting coil 134 will be described. FIG. 3 is a flowchart illustrating one example of a position display process executed by the vehicle ECU 70. The routine of the flowchart is repeatedly executed every predetermined time (for example, every 0.1 seconds or every 0.2 seconds).

When the position display process is executed, the vehicle ECU 70 first detects deviations between the center position of the electric power transmitting coil 134 and the center position of the electric power receiving coil 34 (dis(x1), dis(y1)) based on the image from the rear camera 74 (step S100). dis(x1) is a deviation between the center position of the electric power transmitting coil 134 detected based on the image from the rear camera 74 and the center position of the electric power receiving coil 34 in a front-rear direction of the vehicle. dis(y1) is a deviation between the center position of the electric power transmitting coil 134 detected based on the image from the rear camera 74 and the center position of the electric power receiving coil 34 in a vehicle-width direction. Detection of deviations (dis(x1), dis(y1)) can be performed by specifying the center position of the electric power transmitting coil 134 with respect to the rear camera 74 based on the image from the rear camera 74, and calculating the deviation dis(x1) in the front-rear direction of the vehicle and the deviation dis(y1) in the vehicle-width-direction, based on the specified center position of the electric power transmitting coil 134 and the preset center position of the electric power receiving coil 34 with respect to the rear camera 74.

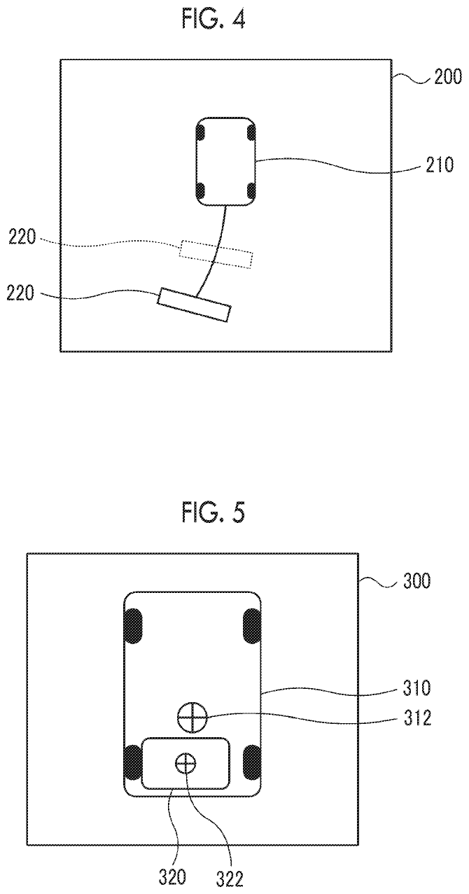

Subsequently, determination is made as to whether or not a current range is the range that allows deviations between the center positions of electric power transmitting coil 134 and the electric power receiving coil 34 to be detected based on the image from the underfloor camera 76 (step S110). The determination can be made according to whether or not the distance between the center positions of the electric power transmitting coil 134 and the electric power receiving coil 34, which can he calculated from the deviations (dis(x1), dis(y1)) detected based on the image from the rear camera 74, is within a predetermined distance (for example, 1, 5 m, 2.0 m, or the like). When determination is made that the current range is not the range that allows deviations between the center positions of the electric power transmitting coil 134 and the electric power receiving coil 34 to be detected based on the image from the underfloor camera 76, the deviations (dis(x1), dis(y1)) detected by the image from the rear camera 74 are set to be deviations (dis(x), dis(y)) of the center positions of the electric power transmitting coil 134 and the electric power receiving coil 34 (step S150). Then, the center position of the electric power transmitting coil 134 with respect to the vehicle is specified based on the deviations (dis(x), dis(y)), and a guidance map is displayed on a display 72 by a first display method of display a position of the first coil schematic diagram with respect to the first vehicle schematic diagram using a first vehicle schematic diagram schematically showing a plane of the vehicle and a first coil schematic diagram schematically showing the electric power transmitting coil 134 (step S160). Then, the position display process ends. FIG. 4 illustrates one example of the guidance map by the first display method. In the example of FIG. 4, the first vehicle schematic diagram 210 is displayed at the upper center of the guidance map 200, and the first coil schematic diagram 220 is displayed at a position calculated from deviations (dis(x), dis(y)) with respect to the preset electric power receiving coil 34 of the first vehicle schematic diagram 210. In addition, in the guidance map by the first display method, a guide line is displayed from the first vehicle schematic diagram 210 to the first coil schematic diagram 220. Therefore, the vehicle can be brought close to the electric power transmitting coil 134 by operating the steering, wheel according to the guide line of the guidance map 200. As the electric vehicle 20 is brought closer to the electric power transmitting coil 134, the guidance map 200 shows that the first coil schematic diagram 220 is brought closer to the first vehicle schematic diagram as indicated by the broken line.

In step S110, when determination is made that the current range is the range that allows deviations between the center positions of the electric power transmitting coil 134 and the electric power receiving coil 34 to be detected based on the image from the underfloor camera 76, the deviations (dis(x2), dis(y2)) between the center positions of the electric power transmitting coil 134 and the electric power receiving coil 34 are detected based on the image from the underfloor camera 76 (step S120). dis(x2) is a deviation between the center position of the electric power transmitting coil 134 detected based on the image from the underfloor camera 76 and the center position of the electric power receiving coil 34 in the front-rear direction of the vehicle. dis(y2) is a deviation between the center position of the electric power transmitting coil 134 detected based on the image from the underfloor camera 76 and the center position of the electric power receiving coil 34 in the vehicle-width direction. Detection of deviations (dis(x2), dis(y2)) can be performed by specifying the center position of the electric power transmitting coil 134 with respect to the underfloor camera 76 based on the image from the underfloor camera 76, and calculating the deviation dis(x2) in the front-rear direction of the vehicle and the deviation dis(y2) in the vehicle-width direction, based on the specified center position of the electric power transmitting coil 134 and the preset center position of the electric power receiving coil 34 with respect to the underfloor camera 76.

Subsequently, the distance Dis between the center position of the electric power transmitting coil 134 and the center position of the electric power receiving coil 34 is calculated using the deviations (dis(x2), dis(y2) detected based on the image of the underfloor camera 76 (step S130). The distance Dis may be obtained by calculating the square root of the sum of the square of dis(x2) and the square of dis(y2). Then, determination is made as to whether or not the distance Dis is equal to or, less than a threshold value Dref (step S140). The threshold value Dref is a threshold value for determining whether or not the center position of the electric power receiving coil 34 and the center position of the electric power transmitting coil 134 are accurately displayed by deviations (dis(x2), dis(y2)) detected based on the image from the underfloor camera 76, and can be set depending on the attached position of the underfloor camera 76, an imaging allowable range, and the like. Since the underfloor camera 76 is mounted approximately at the center of the under floor of the vehicle and forward of the electric power receiving coil 34, it is not possible to detect the deviations (dis(x2), dis(y2)) when the electric power transmitting coil 134 is not within a certain range from the underfloor camera 76. The threshold value Dref can be defined as the certain range. The deviations (dis(x2), dis(y2 detected based on the image from the underfloor camera 76 are more accurate than the deviations (dis(x1), dis(y1)) detected based on the image from the rear camera 74 because, when the distance Dis is equal to or less than the threshold value Dref, the center position of the electric power receiving coil 34 and the underfloor camera 76 are close to each other and the center position of the electric power transmitting coil 134 and the underfloor camera 76 are relatively close to each other. In step S110, determination is made as to whether or not the deviations (dis(x2), dis(y2)) detected based on the image from the underfloor camera 76 can be used by the deviations (dis(x1), dis(y1)) detected based on the image from the rear camera 74 with low accuracy. In step S140, determination is made as to whether or not the deviations (dis(x2), dis(y2)) detected based on the image from the underfloor camera 76 can be used by the deviations (dis(x2), dis(y2)) detected based on the image from the underfloor camera with high accuracy.

When determination is made that the distance. Dis is not equal to or less than the threshold value Dref in step S140, the deviations (dis(x1), dis(y1)) detected based on the image from the rear camera 74 are set to be the deviations (dis(x), dis(y)) between the center position of the electric power transmitting coil 134 and the center position of the electric power receiving coil 34 (step S150), and the guidance map is displayed on the display 72 by the first display method based on the deviations (dis(x), dis(y)) (step S160). Then, the position display process ends.

When determination is made that the distance Dis is equal to or less than the threshold value Drain step S140, the deviations (dis(x2), dis(y2)) detected based on the image from the underfloor camera 76 are set to be the deviations (dis(x), dis(y)) between the center position of the electric power transmitting coil 134 and the center position of the electric power receiving coil 34 (step S170). Then, the center position of the electric power transmitting coil 134 with respect to the vehicle is specified based on the deviations (dis(x), dis(y)), and the guidance map is displayed on the display 72 by a second display method of showing a position of the second coil schematic diagram with respect to the second vehicle schematic diagram, using a second vehicle schematic diagram that displays the schematic diagram of the center position of the electric power receiving coil 34 in the first vehicle schematic diagram and a second coil schematic diagram that displays the schematic diagram of the center position of the electric power transmitting coil 134 in the first coil schematic diagram (step S180). Then, the position display process ends. FIG. 5 illustrates one example of the guidance map by the second display method. In the example of the FIG. 5, the second vehicle schematic diagram 310 is displayed at the upper center of a guidance map 300, where in the second vehicle schematic diagram 310, a center position schematic diagram 312 schematically showing the center position of the electric power receiving coil 34 in the first vehicle schematic diagram 210 enlarged is displayed. Furthermore, a second coil schematic diagram 320 is displayed at a position calculated from the deviations (dis(x), dis(y)) with respect to the center position of the preset electric power receiving coil 34 of the second vehicle schematic diagram 310, where in the second coil schematic diagram 320, a center position schematic diagram 322 schematically showing the center position of the electric power transmitting coil 134 in the first coil schematic diagram 220 enlarged is displayed.

When the distance Dis transitions from a state of being larger than the threshold value Dref to a state of being equal to or less than the threshold value Dref, the display of the guidance map 200 by the first display method (FIG. 4) is switched to the display of guidance map 300 by the second display method (FIG. 5), on the display 72. Here, in the second display method, the second vehicle schematic diagram 310 and the second coil schematic diagram 320 are used. In the second display method, the center position schematic diagram 312 schematically illustrating the center position of the electric power receiving coil 34 and the center position schematic diagram 322 schematically illustrating the center position of the electric power transmitting coil 134, in the first vehicle schematic diagram 210 and the first coil schematic diagram 220, respectively, which are used in the first display method, are displayed. Therefore, when the display of the guidance map 200 by the first display method (FIG. 4) is switched to the display of the guidance map 300 (FIG. 5) by the second display method, two images has continuity, and thus it is possible to suppress the sense of discomfort which a driver would otherwise have felt.

In the electric vehicle 20 of the embodiment described above, when the distance Dis between the center position of the electric power transmitting coil 134 and the center position of the electric power receiving coil 34 is larger than the threshold value Dref, the guidance map 200 is displayed on the display 72 by the first display method of using the first vehicle schematic diagram 210 and the first coil schematic diagram 220 based on the deviations (dis(x1), dis(y1)) detected based on the image from, the rear camera 74 to show the position of the first coil schematic diagram 220 in the first vehicle schematic diagram 210. When the distance Di between the center position of the electric power transmitting coil 134 and the center position of the electric power receiving coil 34 is equal to or less than the threshold value Dref, the guidance map 300 is displayed on the display 72 by the second display method of displaying the position of the second coil schematic diagram 320 with respect to the second vehicle schematic diagram 310, using the second vehicle schematic diagram 310 and the second coil schematic diagram 320 based on the deviations (dis(x2), dis(y2)) detected based on the image from the underfloor camera 76. The second vehicle schematic diagram 310 displays the center position schematic diagram 312 schematically illustrating the center position of the electric power receiving coil 34 in the first vehicle schematic diagram 210 and the second coil schematic diagram 320 displays the center position schematic diagram 322 schematic illustrating the center position of the electric power transmitting coil 134 in the first coil schematic diagram 220. Therefore, when the display of the guidance map 200 by the first display method (FIG. 4) is switched to the display of the guidance map 300 by the second display method (FIG. 5), two images have continuity, and thus it is possible to the sense of discomfort that a driver would otherwise have felt.

In addition, in the electric vehicle 20 of the embodiment, when the distance between the center position of the electric power transmitting coil 134 and the center position of the electric power receiving coil 34 is larger than the threshold value Dref, the guide line from the first vehicle schematic diagram 210 to the first coil schematic diagram 220 is displayed in the guidance map 200 by the first display method. In this way, the operation of the vehicle for parking at the center position of the electric power transmitting coil 134 can be easily performed. When the distance Dis between the center position of the electric power transmitting coil 134 and the center position of the electric power receiving coil 34 is equal to or less than the threshold value Dref, the center position schematic diagram 312 showing the center position of the electric power receiving coil 34 and the center position schematic diagram 322 showing the center position of the electric power transmitting coil 134 are displayed in the guidance map 300 by the second display method. In this way, the operation of the vehicle for parking such that the center position of the electric power receiving coil 34 is aligned with the center position of the electric power transmitting coil 134 can be easily performed.

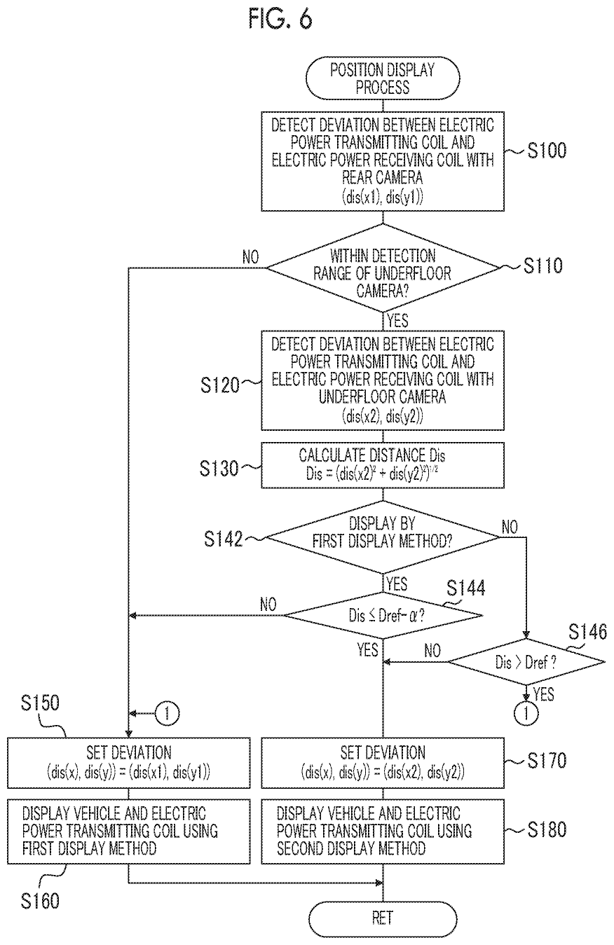

In the electric vehicle 20 of the embodiment, it is assumed that, when the distance Dis between the center position of the electric power transmitting coil 134 and the center position of the electric power receiving coil 34 is larger than the threshold value Dref, the guidance map 200 by the first display method is displayed on the display 72, and when the distance Dis is equal to or less than the threshold, value Dref, the guidance map 300 by the second display method is displayed on the display 72. However, in the switching between the display of the guidance map 200 by the first display method and the display of the guidance map 300 by the second display method, hysteresis may be provided. In this case, a position display process of a modified example illustrated in FIG. 6 may be executed instead of the position display process of FIG. 3. That is, the distance Dis is calculated in step S130, and then determination is made as to whether or not the display at the time of calculating is the display of the guidance map 200 by the first display method (step S142). When the determination is that the display is the display of the guidance map 200 by the first display method, determination is made as to whether or not the distance Dis is equal to or less than the threshold value Dref minus a margin a (for example, 20 cm, 30 cm, and the like) (step S144). When determination is made that the distance Dis is not equal to or less than the threshold value Dref minus the margin α, the display of the guidance map 200 by the first display method continues (steps S150, S160). When determination is made that the distance Dis is equal to or less than the threshold value Dref minus the margin, the display of the guidance map 200 by the first display method is switched to the display of the guidance map 300 by the second display method (steps S170, S180). In step S142, when the determination is that the display is not the display of the guidance map 200 by the first display method, that is, it is the display of the guidance map 300 by the second display method, determination is made as to whether or not the distance Dis is larger than the threshold value Dref (step S146). When the determination that the distance Dis is not, larger than the threshold value Dref, the display of the guidance map 300 by the second display method (steps S170, S180), and when the determination is that the distance Dis is larger than the threshold value Dref, the display of the guidance map 300 by the second display method is switched to the display of the guidance map 200 by the first display method (steps S150, S160). Since hysteresis is provided in switching between the display of the guidance map 200 by the first display method and the display of the guidance map 300 by the second display method as described above, frequent switching between the display of the guidance map 200 by the first display method and the display of the guidance map 300 of the second display method can be suppressed.

In the electric vehicle 20 of the embodiment, two components, that is, the rear camera 74 and the underfloor camera 76 are provided so as to detect the deviations between the center position of the electric power transmitting coil 134 and the center position of the electric power receiving coil 34. However, the disclosure is not limited to the rear camera 74 and the underfloor camera 76 as long as the deviations between the center position of the electric power transmitting coil 134 and the center position of the electric power receiving coil 34 can be detected. For example, the center position of the electric power transmitting coil 134 may be detected by radio waves used by one or both of the electric power transmitting and receiving coils.

In the embodiment, the disclosure is applied to the electric vehicle 20. However, the disclosure may be applied to a hybrid vehicle, a fuel-cell vehicle, or the like, as long as the battery or the power supply is provided.

The correspondence between the main elements of the embodiment and the main elements of the Summary section will be described. The motor 22 in the embodiment corresponds to the electric motor, the battery 26 in the example corresponds to the electric power storage device, the electric power receiving coil 34 in the example corresponds to the electric power receiving coil, the display 72 in the example corresponds to the display, and the vehicle ECU 70 in the example corresponds to the control device. In addition, the electric power transmitting coil 134 in the example corresponds to the electric power transmitting coil.

Further, the correspondence between the main elements of the embodiment and the main elements of the Summary section is not to be construed to limit the elements described in the Summary section, as the embodiment is merely one example for specifically describing a mode carrying out the disclosure described in the Summary section. In other words, the interpretation of the disclosure described in the Summary section is to he made based on the description of the section, and is not be made based on the embodiment, as the embodiment is merely illustrative described in the Summary section.

While the embodiment of the disclosure has been described as above, the disclosure is not limited to the above embodiment, and can be implemented in various forms without departing from the scope of the, disclosure.

The disclosure is applicable to the manufacturing industry of electrified vehicles and the like.

What is claimed is:

1. An electrified vehicle comprising:
a motor configured to output power for traveling;
an electric power storage device configured to supply electric power to the motor;
an electric power receiving coil configured to receive electric power that charges the electric power storage device;
a display disposed in a vicinity of a driver's seat;
a control device;
a first coil position detection sensor configured to detect a relationship between a position of an electric power transmitting coil located outside the vehicle and a position of the electric power receiving coil with first accuracy, when the vehicle is out of “a predetermined distance range; and
a second coil position detection sensor configured to detect the relationship between the position of the electric power transmitting coil and the position of the electric power receiving coil with second accuracy that is more accurate than the first accuracy, when the vehicle is within the predetermined distance range,
wherein the control device is configured to
when the position of the electric power transmitting coil is out of the predetermined distance range from the vehicle, perform display on the display by a first display method of displaying the position of the vehicle and the position of the electric power transmitting coil using a first vehicle schematic diagram and a first coil schematic diagram, the first vehicle schematic diagram schematically showing a plane of the vehicle, and the first coil schematic diagram schematically showing the electric power transmitting coil based on the relationship between the position of the electric power transmitting coil and the position of the electric power receiving coil detected by the first coil position detection sensor, and
when the position of the electric power transmitting coil is within the predetermined distance range from the vehicle, perform display on the display by a second display method of displaying the position of the vehicle and the position of the electric power transmitting coil using a second vehicle schematic diagram and a second coil schematic diagram, the second vehicle schematic diagram specifying a center position of the electric power receiving coil in the first vehicle schematic diagram and the second coil schematic diagram specifying a center position of the electric power transmitting coil in the first coil schematic diagram based on the relationship between the position of the electric power transmitting coil and the position of the electric power receiving coil detected by the second coil position detection sensor.

2. The electrified vehicle according to claim 1, wherein the control, device performs switching from the first display method to the second display method and switching from, the second display method to the first display method with hysteresis.
